(19) United States
(12) Patent Application Publication
(10) Pub. No.: US 2012/0200162 A1
(43) Pub. Date: Aug. 9, 2012

(54) Bi-Directional Grid-Tied Inverter with Series Capacitor for Regulating Voltage of DC Bus

(76) Inventors: Thakoengdet Khuwatsamrit, Atlanta, GA (US); Banjawan Khuwatsamrit, Watkinsville, GA (US)

(21) Appl. No.: 13/364,040

(22) Filed: Feb. 1, 2012

Related U.S. Application Data
(60) Provisional application No. 61/438,735, filed on Feb. 2, 2011.

(51) Int. Cl. H02J 9/06

(52) U.S. Cl. 307/66

(57) ABSTRACT

A series-connected capacitor and battery circuit is constructed to form the dc-bus of a bi-directional, grid-tied inverter. The batteries are the main energy storage components that accept and storage the energy flow from the grid through the inverter. The batteries can also be independently charged from her power generation sources, such as a generator, a photovoltaic system, or a wind-turbine system. The batteries can be discharged and provide power flow back to the grid through the inverter. The series connected capacitors in the dc-bus circuit serves as a controlled voltage source of the dc-bus. The controlled capacitor voltage serves to regulate the dc-bus voltage at a pre-determined level in response to the changing battery voltage. An energy transfer circuit which uses inductor as energy storage media serves to transfer energy from the capacitors to the batteries or vice-versa and provides the mean to control the capacitor voltage.

### REFERENCE TO RELATED APPLICATION

Applicant claims the benefit of U.S. Provisional Patent Application Ser. No. 61/438,735 filed Feb. 2, 2011.

### TECHNICAL FIELD

This invention generally relates to the grid-tied inverters, which are commonly used as power conversion equipment between renewable power generation sources or large battery banks and the grid. More specifically, the invention relates to a circuit and method of using series-connected capacitors to keep the dc-bus voltage of the grid-tied inverter at a pre-determined level. The means for keeping the dc-bus voltage in regulation simplifies the switching pattern generation for the semiconductor switches of the grid-tied inverter and increases reliability and efficiency of the inverter. The invention offers flexibility of using a general purpose grid-tie inverter with batteries of different chemistries, various charge/discharge characteristics, and up to 4 to 1 battery voltage range. The grid-tied inverter with the invented circuit and method can also serve as unity total-power-factor, bi-directional chargers, which are scalable from under 100 watts to above 500 kilo-watts and are capable of controlling power flow from grid to batteries and vice versa. The grid-tied inverter with the invented circuit and method can be used as an Uninterrupted Power Supply (UPS) without the need for a separate battery charger. When the UPS is used in conjunction with static ac line switches, the system becomes a robust online backup ac power sources for critical loads with less component counts than the conventional systems.

### BACKGROUND OF THE INVENTION

Grid-tied inverters, which are power conversion equipment that convert ac electric power from the grid side to the dc power on the dc-bus side and vice versa, are used as interface equipment between renewable power generation sources and the electrical grid. The inverters together with large battery banks are used as d reactive power generator in the grid for frequency stabilization. The inverter-batteries systems are also used as massively distributed energy storage units in the smart grid system. The dc-bus of these grid-tied inverters is made up of the battery banks, the voltages of which are varied as much as to 1 range depending on the state-of-charge of the battery banks and the battery current. Since the inverters must be operated in the inverting mode at all time and never in rectifying mode, the voltage of the dc-bus must be kept higher than the peak ac voltage on the ac side or the grid side. This voltage requirement causes inflexibility in the system design, which has to accommodate charge and discharge characteristics of different types of targeted batteries. The changing of the dc-bus voltage, which is highly non-linear due to battery voltage, also requires complex and high performance controller to control the amplitude and phase angle of the ac currents. There are needs for less complicated control means and more flexibility of using one grid-tied inverter for many battery chemistries and wider voltage range. With the current arts of grid-tied inverters, the designs of distributed energy storage systems required involvement of inverter design engineers due to the inflexibility of handling the full operating voltage range of battery bank. There is a need for off-the-shelf grid-tie inverters that system engineers can use for different battery chemistries and configurations. There is also a need to keep the dc-bus of the grid-tied inverter under 800 volts for a 480V ac system.

There is another grid-tied inverter topology that uses capacitors to form the dc-bus similar to those used in conventional inverters. The dc-bus is connected to the battery banks using a buck-boost converter. The converter serves to regulate the dc-bus and control the charge or discharge current for the battery banks. The efficiency of this topology is lower due to the extra stage of power conversion circuit that operates at full dc-bus voltage. The power loss at the dc-bus is equal to the efficiency of the buck-boost converter multiplied by the entire power flow into or out of the battery banks. The power loss at the dc-bus can be reduced by half, which is significant for high power applications.

In the single phase applications, such as chargers for small off-road, battery-powered vehicles and the upcoming chargers for plug-in hybrid and electric cars, the chargers are unidirectional. Power flows only in one direction, from the grid to the batteries. There are plans in the smart grid technology developments that call for bi-directional chargers for these vehicles. Power flows from grid to vehicle batteries and vice versa. Also, many chargers for off-road vehicles use phase-controlled circuits, which have poor power factor and generate harmonic currents. There are regulations that call for power-factor corrected chargers with near-sinusoidal currents.

Accordingly, it is seen that a need remains for an inverter that overcomes problems associated with inverters of the prior art. It is to the provision of such therefore that the present invention is primarily directed.

### SUMMARY OF THE INVENTION

In a preferred form of the invention an electrical power grid-tieable power conversion inverter having a battery bank and circuit means for controlling de-bus voltage that comprises a capacitor connected in series circuit with the battery bank, an inductor, and switching means for alternately connecting the inductor with the capacitor to transfer energy from the capacitor to the inductor when capacitor voltage exceeds a pre-determined level and for connecting the inductor with the battery bank to transfer energy from the inductor to the battery bank when capacitor voltage is less than the pre-determined level during inverter charging modes of operation.

### BRIEF DESCRIPTION OF THE DRAWINGS

FIG. 1 is the topology of a three-phase, grid-tied inverter with the invented series-connected capacitors and batteries circuit. The inductor-based energy transfer circuit for regulating the dc-bus is also shown in the Figure.

FIG. 2 shows the conventional topology of a three-phase, grid-tied inverter with batteries forming the dc-bus.

FIG. 3 shows the topology of a three-phase, grid-tied inverter with a buck-boost converter to control the charge and discharge of the batteries and to regulate the dc-bus.

FIG. 4 shows the topology of a single-phase, near unit power factor, near sinusoidal current, Bi-directional charger.

### DETAILED DESCRIPTION

With reference next to the drawings, there is shown an inverter embodying principles of the invention in a preferred form.

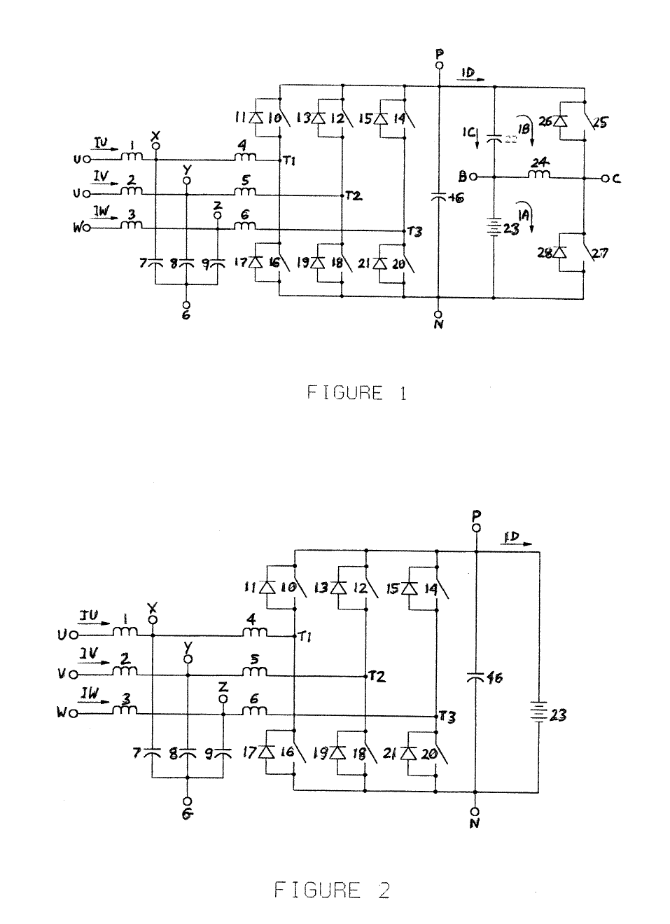

A basic understanding of the invention may be had with reference to FIG. 1. The grid-tied inverter topology consists of 5 circuits as follows:

1. The three-phase line reactors, which are made up of inductors 1, 2, and 3.

2. The PWM carrier frequency filters, which are made up of inductors 4, 5, and 6 and capacitors 7, 8, and 9.

3. The basic three-phase PWM inverter circuit, which are made up of power electronic switches 10, 12, 14, 16, 18, and 20; and anti-parallel diodes 11, 13, 15, 17, 19, and 21; and dc-bus filter capacitor 46.

4. The invented dc-bus circuit, which is made up of a series-connected capacitor 22 and battery bank 23.

5. The energy transfer circuit, which is made up of inductor 24 as energy transfer media, switches 25 and 27, and anti-parallel diodes 26 and 28.

The application objective of this grid-tied inverter is to controlled the amplitude of the line currents iᵤ, iᵥ, and i_{w} and the phase angles of these currents with respect to phase voltages V_{UG}, V_{VG}, and V_{WG}. The control of the phase angles of the line currents determines the direction of the power flow, either from the grid to the battery bank or from the battery bank to the grid. The amplitudes of the currents together with the phase angles determine the amount of real and reactive power flow. The amplitude and phase angle of the line currents are determined by the steady-state, sinusoidal circuit Equations (1), (2), and (3).

j w L₁ i_{U}=V_{UG}−V_{XG} (1)

j w L₂ i_{V}=V_{VG}−V_{VG} (2)

j w L₃ i_{W}=V_{WG}−V_{ZG} (3)

where j is the imaginary unit

w is the angular frequency of the grid

L₁, L₂, and L₃ are inductances of the line reactors 1, 2, and 3

i_{U}, i_{V}, and i_{W} are phasors of the line currents

V_{UG} is the phasor of the voltage across terminals U and G

V_{VG} the phasor of the voltage across terminals V and G

V_{WG} is the phasor of the voltage across terminals W and G

V_{XG} is the phasor of the voltage across terminals X and G

V_{YG} is the phasor of the voltage across terminals Y and G

V_{ZG} is the phasor of the voltage across terminals Z and

Assuming V_{XG}, V_{YG}, and V_{ZG} are sinusoidal voltages with angular frequency w.

Also assuming the inverter is operating in inverting mode at all time. This means that the voltage of the dc-bus or the voltage across terminals P and N or V_{PN} must be higher than the highest peak line voltage of the ac lines (V_{UV}, V_{VW}, and V_{WU}) at all time.

Equation (1) shows that the desirable values of amplitude and phase angle of iᵤ can be achieved by generating the right amplitude and phase angle of V_{XG}. V_{XG} is generated by the dc-bus voltage, V_{PN}, and the inverter switching pattern. If V_{PN} is kept constant, a simple triangular PWM switching method can be use to generate the desired V_{XG}. V_{YG} and V_{ZG} can be generated using 120° and 240° phase shift with respect to the phase angle of V_{XG} and according to the phase rotation of V_{VG}, V_{WG}.

Referring again to FIG. 1, equations that described the working of the de-bus circuit and the energy transfer circuit can be written as follows:

V_{PN}=V_{PB}+V_{BN} (4)

i_{C}=i_{D}−i_{B} (5)

where V_{PN} the dc-bus voltage in Volts

V_{PB} is the series capacitor (item 22 in FIG. 1) voltage in Volt

V_{BN} is the battery bank (item 23 in FIG. 1) voltage in Volt

i_{C} is the series capacitor current in Ampere

i_{D} is the dc-bus current in Ampere

i_{B} is the energy transfer circuit current in Ampere when switch 25 is closed

i_{B} is zero when switch 25 is open and diode 26 is not conducting

Maintaining the dc-bus voltage, VPN, at a pre-determined setting by controlling voltage of the series capacitors 22 is the key principle of this invention. The operation of this control principle is described in three modes of operation as follows:

Battery 23 charging mode (energy flows from the grid or ac lines to battery 23)

Battery 23 discharging mode (energy flows from batteries 23 to the grid)

Battery 23 float-charge mode or quiescent mode (no energy flows in either directions)

In battery 23 charging mode, i_{D} is positive. The voltage of the capacitors 22, VPB and the voltage of battery bank 23, VBN are increasing. As the result the dc-bus voltage, V_{PN}, increases according to Equation (4). However the control principle of the inverter calls for regulating V_{PN} at a pre-determined level. V_{PN} can be regulated by decreasing capacitor 22 voltage, V_{PB}, or creating a net discharge of the capacitor within the switching period, T, of the energy transfer circuit. The net discharge condition and the amount of net discharge current can be controlled by turning on switch 25 of the energy transfer circuit at the proper amount of time, Tₒₙ, within the T switching period. When Switch 25 is turned on, the current i_{B} increases (see FIG. 1). Energy is transferred from capacitor 22 to inductor 24 during the Tₒₙ₂₅ period. When switch 25 is turned off, the energy stored in inductor 24 during the Tₒₙ₂₅ period is transferred into battery bank 23 via diode 28. No energy is wasted. The net discharge energy from capacitor 22 is used as added charging for battery bank 23. The energy transfer circuit can be operated in either discontinuous or continuous conduction mode. The switch period T can be fixed or varied. In summary the control objective of switch 25 is to generate the right amount of net discharge of capacitor 22 to keep the dc-bus voltage, V_{PN}, in regulation.

In battery 23 discharging mode, i_{D} is negative. The voltage of the capacitors 22, V_{PB} the voltage of battery bank 23, V_{BN} are decreasing. As the result the dc-bus voltage, V_{PN}, decreases. In this case, V_{PN} can be regulated by increasing capacitor 22 voltage, V_{PB}, or creating a net charging condition for the capacitor within the switching period, T, of the energy transfer circuit. The net charging condition and the amount of net charging current can be controlled by turning on switch 27 of the energy transfer circuit at the proper amount of time, Tₒₙ₂₇, within the T switching period. When Switch 27 is turned on, the current i_{A}increases (see FIG. 1). Energy is transferred from battery 23 to inductor 24 during the Tₒₙ₂₇ period. When switch 27 is turned off, the energy stored in inductor 24 during the Tₒₙ₂₇ period is transferred into capacitor 22 via diode 26. The transferred energy creates a net charging condition at capacitor 22 and keeps the dc-bus voltage in regulation. The control of the switching of switch 27 is similar to that described for controlling switch 25 in the last paragraph.

In the quiescent mode, neither charging nor discharging of the battery bank 23 is required. However a small amount of energy needs to be drawn from the grid to keep battery bank 23 in the float charge state and to replenish the energy loss in the system to keep the dc-bus voltage in regulation. The energy transfer circuit is used on an as needed basis to condition the battery bank 23 and to perform online and automated maintenance testing of the battery bank.

The single-phase, bi-directional, gird-tied inverter shown in FIG. 4 can be operated similar to those described for the three-phase counterpart in the previous paragraphs. The invented series-connected capacitor 22 and battery bank 23 circuit provides unity power factor and near sinusoidal current in both charging and discharging operations. The inverter is suitable as small charger for plug-in hybrid and battery-powered vehicles. The bi-directional capability supports the massively distributed energy storage policy in the smart grid system.

In conclusion, a series-connected circuit of capacitors and batteries forms the dc-bus of the grid-tied inverters as shown in FIG. 1. An energy transfer circuit, which uses inductor as energy storage media, provides means for energy transfer between the capacitors and the batteries. The purpose of using the series capacitor and the energy transfer circuit is to create a high efficiency control mean to regulate the overall dc-bus voltage at a pre-determined level. The regulated dc-bus offers a simple, reliable, and robust control and generation of near unit power factor and near sinusoidal ac line currents as compared to the conventional grid-tied inverter shown in FIG. 2.

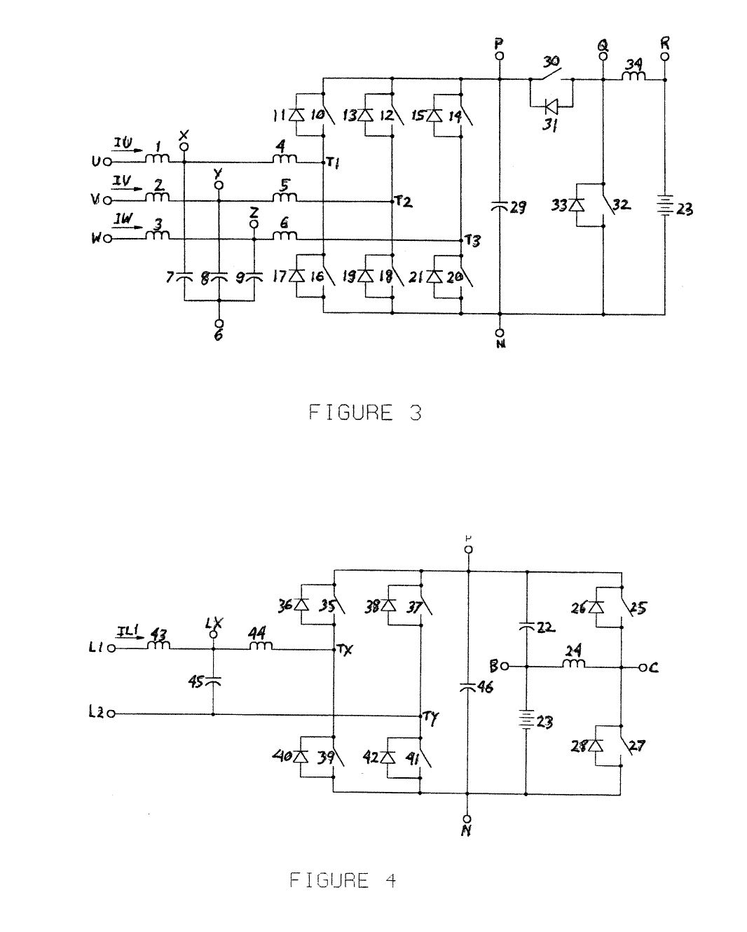

The series connected capacitors provide a mean for regulated dc-bus with faction of the power loss of the grid-tied inverter pluses buck-boost converter topology shown in FIG. 3. In the charging mode, the dc-bus current charges up the capacitors as well as the batteries. The voltage of the capacitors is controlled by transferring energy from the capacitors into the batteries being charged and no energy is wasted to keep the dc-bus under regulation. In the discharge mode, energy is drained from the batteries as well as the capacitors but the dc-bus voltage is still regulated by transferring energy from the batteries to the capacitors. The amount of energy needed by the capacitors to keep the dc-bus in regulation in the invented topology of FIG. 1 is only a faction of the energy needed by the capacitors in the buck-boost topology of FIG. 3. Less energy transfer means less loss and hence higher efficiency.

The single-phase bi-directional charger shown in FIG. 4 offers near unity power factor and near sinusoidal current. Near unit total power factor chargers are needed for both plug-in hybrid and battery power vehicles. Bi-directional power flow chargers are essential in the development of the smart grid system. Every battery-powered vehicle is the potential source of the massively distributed energy storage systems in the smart grid.

It thus is seen that an inverter is now provided which overcomes problems with those of the prior art. While this invention has been described in detail with particular references to the preferred embodiments thereof, it should be understood that many modifications, additions and deletions, in addition to those expressly recited, may be made thereto without departure from the spirit and scope of the invention.

1. An electrical power grid-tieable power conversion inverter having a battery bank and circuit means for controlling de-bus voltage that comprises a capacitor connected in series circuit with the battery bank, an inductor, and switching means for alternately connecting the inductor with the capacitor to transfer energy from the capacitor to the inductor when capacitor voltage exceeds a pre-determined level and for connecting the inductor with the battery bank to transfer energy from the inductor to the battery bank when capacitor voltage is less than the pre-determined level during inverter charging modes of operation.

2. The power conversion inverter of claim 1 having second switching means for alternately transferring energy from the battery bank to the inductor and energy from the inductor to the capacitor during inverter discharge modes of operation.

3. An electrical power grid-tieable power conversion inverter having a battery and circuit means for controlling de-bus voltage that comprises a capacitor connected in series circuit with the battery, an inductor, and switching means for alternately transferring energy from the battery to the inductor and energy from the inductor to the capacitor during inverter discharge modes of operation.

4. An electrical power grid-tieable power conversion inverter having a battery bank and circuit means for controlling de-bus voltage which comprises a capacitor connected in series circuit with the battery bank, an inductor, and switch means for timed connection of the inductor with the capacitor in transferring energy from the capacitor to the inductor and for timed connection of the inductor with the battery bank in transferring energy from the inductor to the battery bank when the inverter is in a charge mode of operation.

5. The power conversion inverter of claim 4 wherein the inductor is alternatively placed in parallel circuit with the capacitor and the battery bank by operation of said switch means.

6. The inverter of claim 4 having second switching means for timed connection of the inductor in parallel with the battery bank in transferring energy from battery bank to the inductor and energy from the inductor to the capacitor when the inverter is in a discharge mode of operation.

7. A method of operating an inverter connected to an electrical power grid during power conversion operations, the inverter having a capacitor connected in series circuit with a battery bank and an inductor, wherein during inverter charging operations energy is alternatively transferred from the capacitor to the inductor and from the inductor to the battery bank.

8. The method of claim 7 wherein during inverter discharge operations energy is alternatively transferred from the battery bank to the inductor and from the inductor to the capacitor.

9. A method of operating an inverter connected to an electrical power grid during power conversion operations, the inverter having a capacitor connected in series circuit with a battery bank and having an inductor, wherein during inverter discharge operations energy is alternatively transferred from the battery bank to the inductor and from the inductor to the capacitor.
